(19) United States
(12) Patent Application Publication
(10) Pub. No.: US 2003/0204832 A1
(43) Pub. Date: Oct. 30, 2003

(54) Automatic generation method of dummy patterns

(75) Inventor: Akira Matumoto, Nakahara-ku (JP)

Correspondence Address: Norman P. Soloway, HAYES SOLOWAY PC, 130 W. Cushing Street, Tucson, AZ, 85701, US

(73) Assignee: NEC Electronics Corporation

(21) Appl. No.: 10/423,069

(22) Filed: Apr. 25, 2003

(30) Foreign Application Priority Data
Apr. 26, 2002 (JP) 126140/2002

(51) Int. Cl. G06F 17/50; G06F 9/455

(52) U.S. Cl. 716/19; 716/11

(57) ABSTRACT

An automatic generation method of dummy patterns of the present invention includes: a first step of preparing a plurality of dummy pattern components which have regularly arranged dummy patterns, respectively, and for which priorities are set based upon a predetermined rule; a second step of selecting one of the plurality of dummy pattern components and arranging dummy patterns belonging to the selected dummy pattern component to overlap layout data of mask patterns for which arrangement prohibition regions are set; a third step of deleting dummy patterns which are in contact with or overlap the arrangement prohibition regions among the arranged dummy patterns; and a fourth step of deleting dummy patterns belonging to the dummy pattern component with a lower priority in the case in which a plurality of dummy patterns are in contact with or overlap each other.

### BACKGROUND OF THE INVENTION

1. Field of the Invention

The present invention relates to an automatic generation method of dummy patterns in mask pattern design, and in particular to an automatic generation method of dummy patterns to be arranged in mask pattern design in order to improve planarity of a surface of a semiconductor substrate.

2. Description of the Prior Art

In recent years, wiring which connects elements has become finer in an integrated circuit, and satisfactory planarization of a substrate surface has been required in order to form a fine pattern with high accuracy.

For example, in formation of damascene interconnects, a method is used with which grooves for wiring are formed in an insulating film on a surface of a silicon substrate and, after metal for wiring is deposited over the entire surface to fill the grooves, the metal other than that inside the grooves is removed by the chemical mechanical polishing (CMP) to planarize the surface. Polishing with the CMP progresses fast in a region where a density of the grooves (i.e., wiring density) is high and slow in a region where the density is low. Thus, if the grooves are arranged irregularly, the polishing cannot be performed uniformly. Consequently, a film thickness of the wiring after the polishing becomes small in the region where the density of the grooves is high and becomes large in the region where the density of the grooves is low. Non-uniformity of the film thickness of the wiring causes increase in irregularity of a wiring resistance and is undesirable.

In order to improve this point, a technique has been conventionally used, with which a density of grooves at the time of polishing is made uniform by providing dummy patterns in advance in a part where wiring patterns (corresponding to grooves) are thin to prevent non-uniformity of a film thickness. For example, as shown in FIG. 1A, Japanese Patent Laid-Open No. 5-343546 discloses a technique for arranging square patterns in an X direction and a Y direction in vacant regions where no wiring exists to form dummy patterns. In addition, as shown in FIG. 2A, there is also known a technique for dislocating positions of dummy patterns for each row and column to arrange the dummy patterns in order to further improve a planarization effect.

In both of these techniques, since square patterns of an identical shape and an identical size are used as dummy patterns, automatic generation of dummy patterns is easy. The automatic generation of dummy patterns is carried out as described below. First, regions including wiring patterns of a high density are set as dummy prohibition regions (6 in FIGS. 1A and 8 in FIG. 2A) in which arrangement of dummy patterns is prohibited. Next, dummy patterns (7 in FIGS. 1A and 9 in FIG. 2A) are arranged on an entire surface of mask pattern regions. Next, dummy patterns which are in contact with or overlap the dummy prohibition regions are eliminated. In this way, the dummy patterns 7 and 9 are generated in the vacant regions where the dummy prohibition regions 6 and 8 do not exist.

However, in the conventional dummy patterns and automatic generation method thereof described above, dummy patterns may not be generated in regions, where the dummy patterns should be arranged, due to a relationship between a size of the dummy patterns and positions of the dummy prohibition regions. FIGS. 1A and 2A show the case in which an interval between the set dummy prohibition regions is larger than a dimension in X direction of the dummy patterns by two grids.

Here, in grids (grids for wiring) 10, one grid indicates a wiring width of a standard wiring pattern and also indicates a standard wiring interval which should be provided between adjacent two wiring patterns. That is, a smallest pitch of wiring is two grids. However, here, a relationship between the grids and the wiring width and wiring interval is indicated only for conveniences' sake. When it is applied to actual wiring, the wiring patterns are adjustable as long as the smallest pitch of wiring is two grids, for example, the wiring width is (one grid+α) and the wiring interval is (one grid−α), by thickening processing or the like.

In FIG. 1A or FIG. 2A, since the interval between the dummy prohibition regions is slightly larger than the dimension in X direction of the dummy pattern, after the dummy patterns which are in contact with or overlap the dummy prohibition regions 6 are deleted, regions where dummy patterns are not arranged are generated between two dummy prohibition regions as shown FIG. 1B or FIG. 2B.

If dummy patterns are minimized to, for example, a size of one grid, it is possible to arrange the dummy patterns surely even in the case in which an interval between dummy prohibition regions is small. However, minimizing the size of the dummy patterns is not preferable because it increases a data volume of the dummy patterns markedly.

As another technique relating to the present invention, Japanese Patent Laid-Open No. 2001-176959 discloses a technique for arranging two types of small and large dummy patterns properly according to vacant areas of regions where the dummy patterns should be arranged. That is, the dummy patterns of a large size are arranged in vacant regions with a large area, and the dummy patterns of a small size are arranged in vacant regions with a small area between the dummy prohibition regions of FIG. 1B or FIG. 2B. In this way, by properly using the two types of large and small dummy patterns, it is possible to control increase in a data volume and arrange dummy patterns even in regions where the interval between the dummy prohibition regions is small. However, Japanese Patent Laid-Open No. 2001-176959 does not disclose a method of automatically realizing such arrangement of dummy patterns rather than manually doing so.

As another technique relating to the present invention, Japanese Patent Laid-Open No. 2001-351984 discloses a technique with which layout data of mask patterns and an overlapping position of models of dummy patterns are gradually changed, whereby a provability of including basic elements of the models of the dummy patterns in dummy pattern arrangement portions increases, and unfilled portions of the dummy patterns are reduced. However, there is no specific description for arranging dummy patterns automatically in Japanese Patent Laid-Open No. 2001-351984 either.

In an integrated circuit of recent years in which elements have become finer and an enormous number of grids for wiring are included, it has become impossible to perform all or important parts of arrangement processing of dummy patterns manually. Thus, in the case in which dummy patterns are used, automatic generation of dummy patterns is an essential technique.

### SUMMARY OF THE INVENTION

The present invention has been devised in view of the above-described circumstance, and it is an object of the present invention to provide an automatic generation method of dummy patterns which is capable of arranging dummy patterns in regions where an interval between dummy prohibition regions is small and controlling increase in data volume.

An automatic generation method of dummy patterns according to a first aspect of the present invention includes: a first step of preparing a plurality of dummy pattern components which have regularly arranged dummy patterns, respectively, and for which priorities are set based upon a predetermined rule; a second step of selecting one of the plurality of dummy pattern components and arranging dummy patterns belonging to the selected dummy pattern component to overlap layout data of mask patterns for which arrangement prohibition regions are set; a third step of deleting dummy patterns which are in contact with or overlap the arrangement prohibition regions among the arranged dummy patterns; and a fourth step of deleting dummy patterns belonging to the dummy pattern component with a low priority in the case in which a plurality of dummy patterns are in contact with or overlap each other.

An automatic generation method of dummy patterns according to a second aspect of the present invention includes: a first step of preparing a basic dummy pattern component having dummy patterns regularly arranged on grids for wiring; a second step of arranging the dummy patterns of the basic dummy pattern component to overlap layout data of mask patterns arranged on grids for wiring in advance such that both the grids for wiring coincide with each other; a third step of deleting dummy patterns which are in contact with or overlap arrangement prohibition regions among the dummy patterns of the basic dummy pattern component; a fourth step of moving the dummy patterns of the basic dummy pattern component in an X direction and a Y direction by one grid for wiring, respectively, to create a new dummy pattern component; a fifth step of arranging dummy patterns of the new dummy pattern component such that grids for wiring coincide with the layout data of the mask patterns; a sixth step of deleting dummy patterns which are in contact with or overlap the arrangement prohibition regions among the dummy patterns of the new dummy pattern component; a seventh step of deleting dummy patterns which are in contact with or overlap dummy patterns arranged earlier than the fifth step among the dummy patterns belonging to the new dummy pattern component; and an eighth step of judging whether or not the fourth to seventh steps are repeated a predetermined number of times and, in the case in which the steps have not been repeated the predetermined times, returning to the fourth step with the new dummy pattern component as a basic dummy pattern component.

The above-described objects and characteristics and other objects and characteristics related thereto of the present invention will be apparent if descriptions based upon accompanying drawings and new matters thereof pointed out in claims are read.

### BRIEF DESCRIPTION OF THE DRAWINGS

Respective drawings used in a detailed description of the present invention will be described briefly such that the drawings can be understood better, in which:

FIG. 1A is a schematic view of a layout for explaining a conventional arrangement and automatic generation method of dummy patterns;

FIG. 1B is a schematic view of a layout for explaining problems in the conventional automatic generation method of dummy patterns;

FIG. 2A is a schematic view of a layout for explaining the conventional arrangement and automatic generation method of dummy patterns;

FIG. 2B is a schematic view of a layout for explaining problems in the conventional automatic generation method of dummy patterns;

FIG. 3 is a block diagram showing an example of a structure of an apparatus in which the method of the present invention can be implemented;

FIG. 4 is a flow diagram of a first embodiment according to a first aspect of the present invention;

FIG. 5A is a schematic view showing an example of a dummy pattern component of dummy patterns of a large size;

FIG. 5B is a schematic view showing an example of a dummy pattern component of dummy patterns of a small size;

FIG. 6A is a schematic view of a layout after processing of step S5 at the time of arrangement of the dummy patterns of a large size in the flow diagram of FIG. 4;

FIG. 6B is a schematic view of a layout after processing of step S6 at the time of arrangement of the dummy patterns of a large size in the flow diagram of FIG. 4;

FIG. 7A is a schematic view of a layout after processing of step S5 at the time of arrangement of the dummy patterns of a small size in the flow diagram of FIG. 4;

FIG. 7B is a schematic view of a layout after processing of step S6 at the time of arrangement of the dummy patterns of a small size in the flow diagram of FIG. 4;

FIG. 8 is a schematic view of a layout after processing of step S7 at the time of arrangement of the dummy patterns of a small size in the flow diagram of FIG. 4;

FIG. 9 is a flow diagram of a second embodiment according to the first aspect of the present invention;

FIG. 10A is a schematic view showing an example of an arrangement of the dummy patterns of a large size different from the dummy pattern component of FIG. 5A;

FIG. 10B is a schematic view showing an example of an arrangement of the dummy patterns of a small size different from the dummy pattern component of FIG. 5B;

FIG. 11A is a schematic view of a layout after processing of step S14 in the flow diagram of FIG. 9;

FIG. 11B is a schematic view of a layout after processing of step S16 in the flow diagram of FIG. 9;

FIG. 12 is a flow diagram of a third embodiment according to the first aspect of the present invention;

FIG. 13 is a schematic view showing an example of a basic dummy pattern component of dummy patterns;

FIG. 14 is a view schematically showing arrangements of dummy patterns in the basic dummy pattern component and a plurality of dummy pattern components created by repeating steps S22 to S23 in the flow diagram of FIG. 12;

FIG. 15A is a schematic view of a layout after processing of step S25 is applied to a dummy pattern component with a highest priority in the flow diagram of FIG. 12;

FIG. 15B is a schematic view of a layout after processing of step S26 is applied to the dummy pattern component with a highest priority in the flow diagram of FIG. 12;

FIG. 16A is a schematic view of a layout after processing of step S25 is applied to a dummy pattern component with a second highest priority in the flow diagram of FIG. 12;

FIG. 16B is a schematic view of a layout after processing of step S27 is applied to the dummy pattern component with a second highest priority in the flow diagram of FIG. 12;

FIG. 17A is a schematic view of a layout after processing of step S25 is applied to a dummy pattern component with a fourth highest priority in the flow diagram of FIG. 12;

FIG. 17B is a schematic view of a layout after processing of step S27 is applied to the dummy pattern component with a fourth highest priority in the flow diagram of FIG. 12;

FIG. 18 is a flow diagram of a fourth embodiment according to the first aspect of the present invention; and

FIG. 19 is a flow diagram of an embodiment of a second aspect of the present invention.

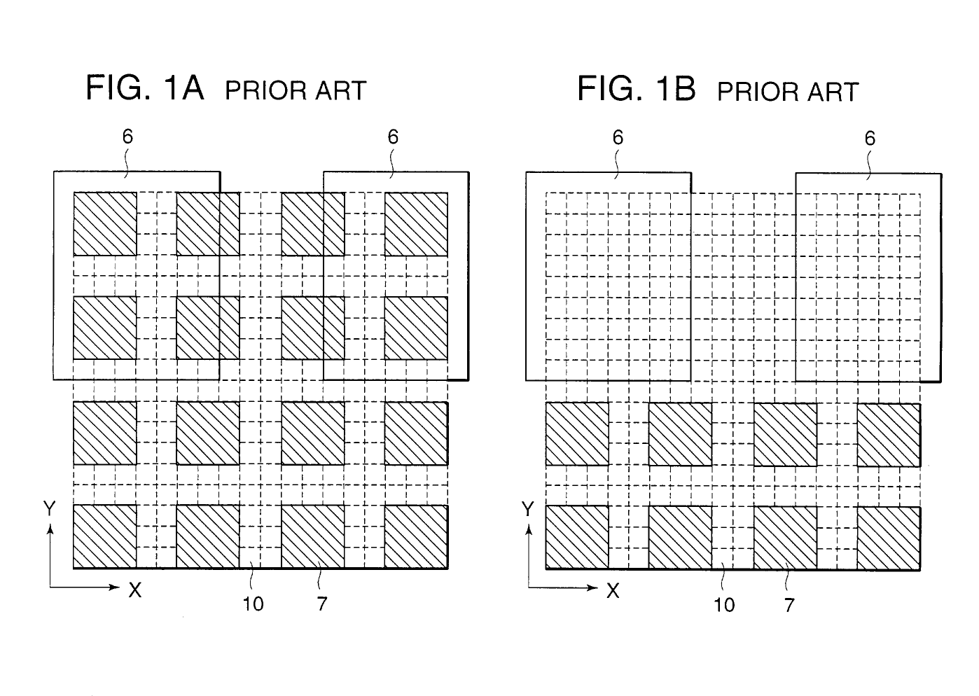

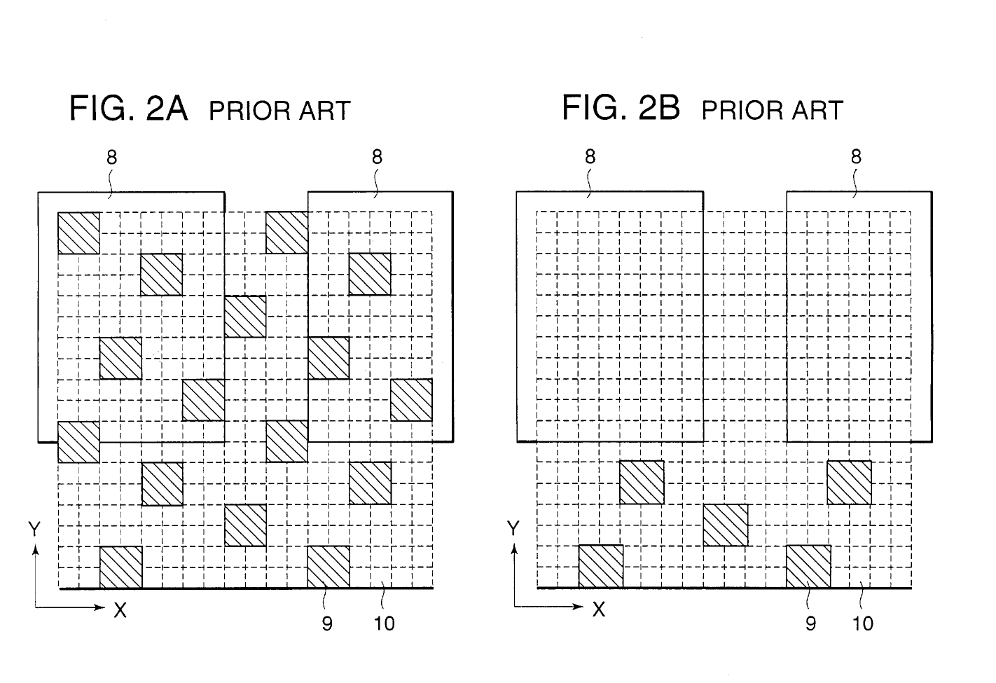

### DETAILED DESCRIPTION OF THE PREFERRED EMBODIMENTS

Preferred embodiments of the present invention will be hereinafter described in detail with reference to the accompanying drawings. Note that the following description indicates embodiments of the present invention, and the present invention should not be interpreted as being limited to the following description.

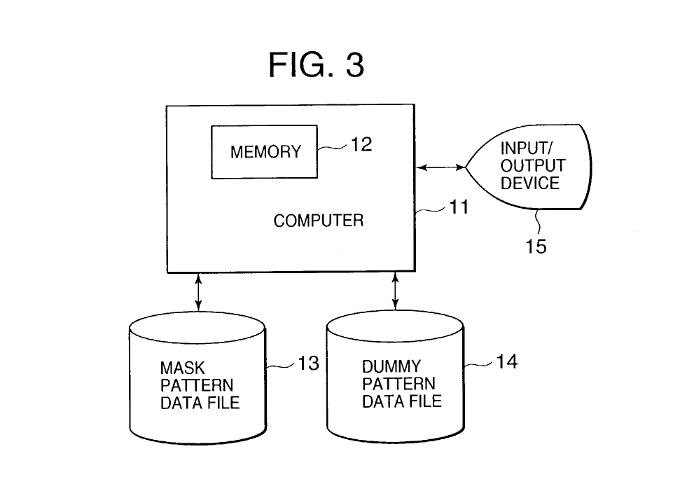

FIG. 3 is a block diagram showing an example of a structure of an apparatus which is capable of performing automatic arrangement of dummy patterns using a method of the present invention. In the figure, reference numeral 11 denotes a computer and 12 denotes a memory for storing a program which is provided in the computer 11 and in which the method of the present invention is described. Reference numeral 13 denotes a dummy pattern data file for storing dummy pattern components. Reference numeral 14 denotes a mask pattern data file for storing layout data of mask patterns.

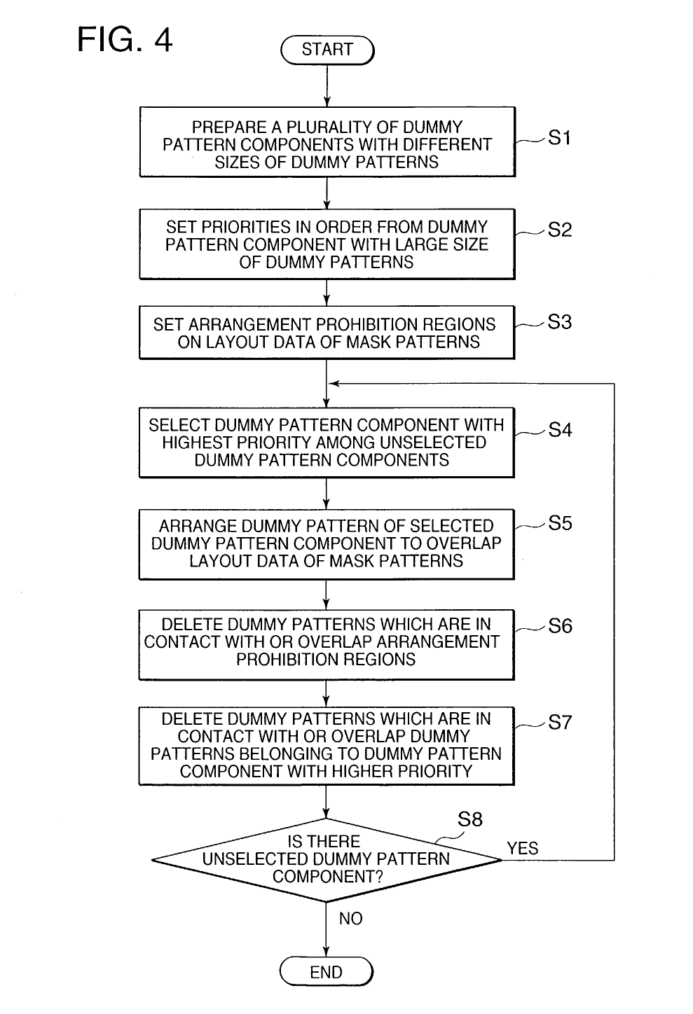

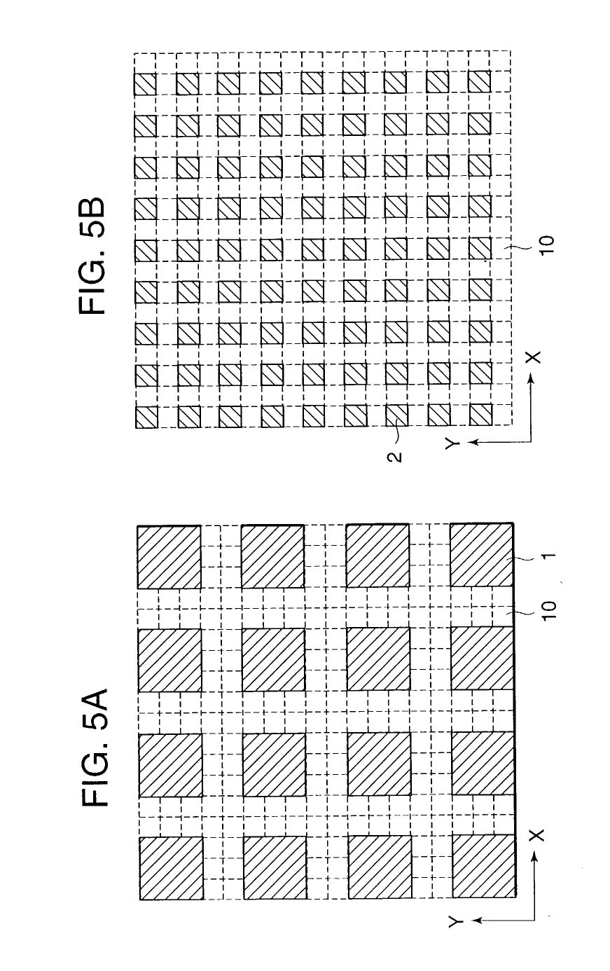

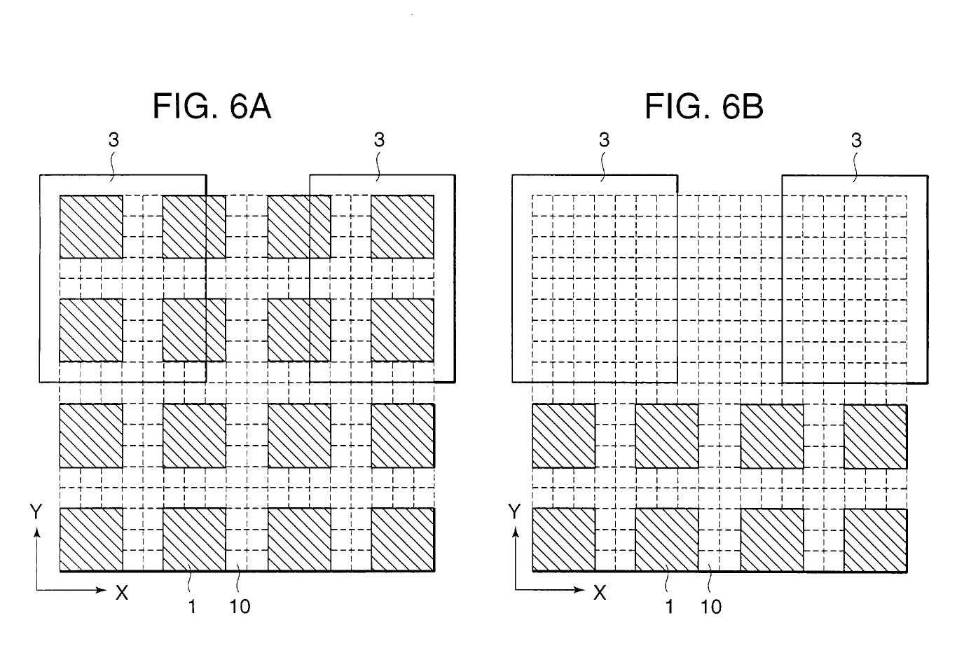

FIG. 4 is a flow diagram of a first embodiment according to a first aspect of the present invention. The first embodiment will be described in accordance with the flow diagram of FIG. 4 with reference to FIGS. 5A and 5B showing a dummy pattern component, FIGS. 6A, 6B, 7A, 7B, and 8, which are schematic views of layouts corresponding to main steps of FIG. 4, as required in the description.

First, in step S1, a plurality of dummy pattern components with different sizes of dummy patterns are prepared. In this embodiment, there are two types of dummy pattern components as shown in FIGS. 5A and 5B, which are stored in the dummy pattern data file 14 with different layers assigned, respectively. In step S1, two dummy pattern components are read in the computer 11. In a dummy pattern component shown in FIG. 5A, large dummy patterns 1 are regularly arranged in a matrix shape on grids for wiring (hereinafter simply referred to as grids) 10. In a dummy pattern component shown in FIG. 5B, small dummy patterns 2 are regularly arranged in a matrix shape on the girds 10.

In this embodiment, in the grids 10, one grid indicates a wiring width of a standard wiring pattern and also indicates a standard wiring interval which should be provided between two adjacent wiring patterns. That is, a smallest pitch of wiring is two grids. However, here, a relationship between the grids and the wiring width and wiring interval is indicated only for conveniences' sake. When it is applied to actual wiring, the wiring patterns is adjustable as long as the smallest pitch of wiring is two grids, for example, the wiring width is (one grid+α) and the wiring interval is (one grid−α), by thickening processing or the like.

Next, in step S2, priorities of dummy pattern components are set for the prepared plurality of dummy pattern components in an order of sizes of the dummy patterns. The dummy pattern component shown in FIG. 5A is given a higher priority, and the dummy pattern component shown in FIG. 5B is given a lower priority.

The plurality of dummy pattern components for which priorities are set are prepared according to steps S1 and S2.

Next, in step S3, the computer 11 reads in layout data of mask patterns from the mask pattern data file 13, and the computer 11 sets arrangement prohibition regions of dummy patterns in the layout data of the mask patterns. As shown in FIG. 6A, arrangement prohibition regions 3 are set on the grids 10. The arrangement prohibition regions 3 are regions in which dummy patterns are not allowed to be arranged because, for example, the grids have already been occupied by wiring patterns.

Next, in step S4, the computer 11 selects a dummy pattern component with a highest priority among the unselected dummy pattern components. The dummy pattern component of FIG. 5A is selected.

Next, in step S5, the computer 11 arranges the large dummy patterns 1 of the selected dummy pattern component to overlap the layout data of the mask patterns. As shown in the schematic view of layout of FIG. 6A, the large dummy patterns 1 are arranged on the layout data of the mask patterns such that grids of the dummy pattern component and grids of the layout data of the mask patterns coincide with each other.

Next, in step S6, when the large dummy pattern 1 are in contact with or overlap the arrangement prohibition regions 3, the computer 11 deletes the large dummy patterns. Processing for deleting the large dummy patterns which are in contact with or overlap the arrangement prohibition regions 3 is performed by a graphical operation. For example, the arrangement prohibition regions 3 are enlarged in the X direction and the Y direction by a size of the large dummy patterns 1, respectively, and the large dummy patterns 1 included in the enlarged arrangement prohibition regions are set as objects of deletion. As shown in the schematic view of a layout of FIG. 6B, since the large dummy patterns 1 overlapping the arrangement prohibition regions 3 have been deleted, the large dummy patterns 1 are not arranged between the two arrangement prohibition regions 3 at this stage.

Next, in step S7, in the case in which the plurality of dummy patterns are in contact with or overlap each other, the computer 11 leaves dummy patterns belonging to the dummy pattern component with a higher priority as they are and deletes only dummy patterns belonging to the dummy pattern component with a lower priority. Since the arranged dummy patterns are only the large dummy patterns 1 in FIG. 6B, the computer 11 proceeds to step S8.

In step S8, the computer 11 judges whether or not there is an unselected dummy pattern component. Since the dummy pattern component having the small dummy patterns 2 shown in FIG. 5B is unselected, the computer 11 returns to step S4.

In step S4, the computer 11 selects the dummy pattern component having the small dummy patterns shown in FIG. 5B which is the unselected dummy pattern component.

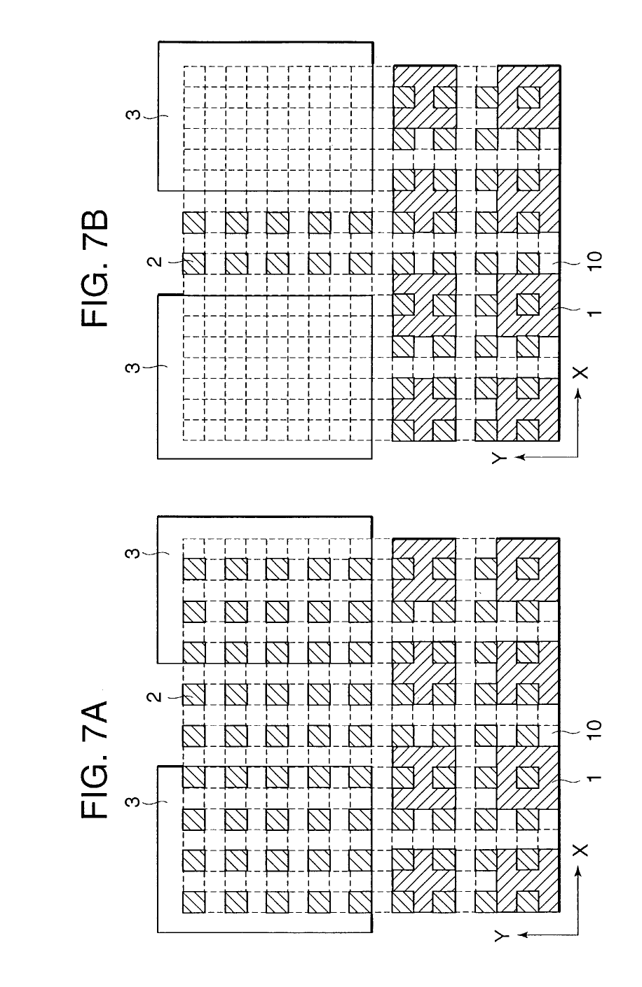

In step S5, the computer 11 arranges the dummy patterns 2 of the selected dummy pattern component to overlap the layout data of the mask patterns. As shown in a schematic view of a layout of FIG. 7A, the dummy patterns 2 are arranged on the layout data of the mask patterns such that grids of the dummy pattern component and grids of the layout data of the mask patterns coincide with each other.

Next, in step S6, the computer 11 deletes the small dummy patterns 2 which is in contact with or overlap the arrangement prohibition regions 3, and a layout as shown in a schematic view of FIG. 7B is obtained.

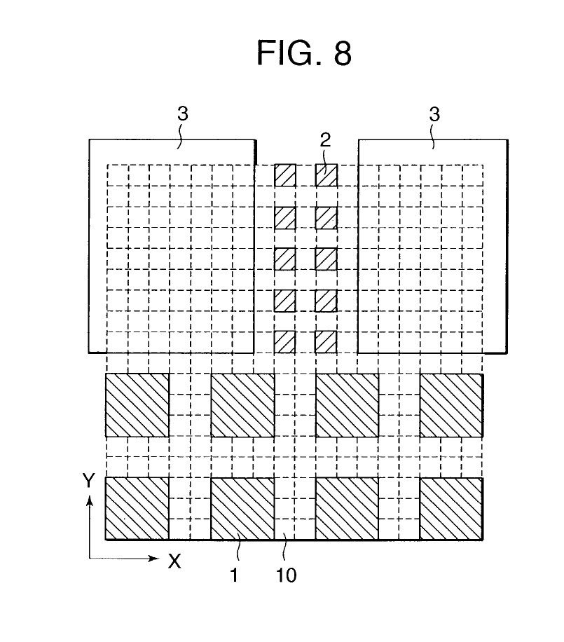

In step S7, in the case in which the plurality of dummy patterns are in contact with or overlap each other, the computer 11 leaves the large dummy patterns 1 belonging to the dummy pattern component with a higher priority as they are and deletes the small dummy patterns 2 belonging to the dummy pattern component with a lower priority. As a result, a layout as shown in a schematic view of FIG. 8 is obtained. Deletion processing of the small dummy patterns 2 which are in contact with or overlap the large dummy patterns 1 is performed by a graphical operation. For example, the large dummy patterns 1 are enlarged in the X direction and the Y direction by a size of the small dummy patterns 2, respectively, and the small dummy patterns 2 included in the enlarged large dummy patterns are set as objects of deletion.

Next, in step S8, the computer 11 judges whether or not there is an unselected dummy pattern component. Since there is no unselected dummy pattern component, the computer 11 ends generation of dummy patterns.

According to the method of this embodiment, as shown in a schematic view of a layout of FIG. 8, since the small dummy patterns 2 are arranged between the two arrangement prohibition regions 3 and the large dummy patterns 1 are arranged in a vacant region of a large area, an automatic generation method of dummy patterns is realized which can arrange dummy patterns even in a region with a small interval between adjacent two dummy prohibition regions and can control increase in a data volume. In order to surely arrange dummy patterns in the region with a small interval between adjacent two dummy prohibition regions, it is desirable to set a size of the dummy patterns belonging to the dummy pattern component of a lowest priority (i.e., smallest dummy patterns) to the same size as the grids.

In this embodiment, the case in which there are two dummy pattern components is described for simplicity of explanation. However, the flow of FIG. 4 can be carried out also in the case in which there are three or more dummy pattern components. Note that step S3 of FIG. 4 may be performed before step S1. In addition, in the description of this embodiment, the case in which dummy patterns and arrangement prohibition regions are arranged on grids is explained. However, the flow of FIG. 4 is not limited to this but can be applied to the case in which dummy patterns and arrangement prohibition regions are arranged without grids.

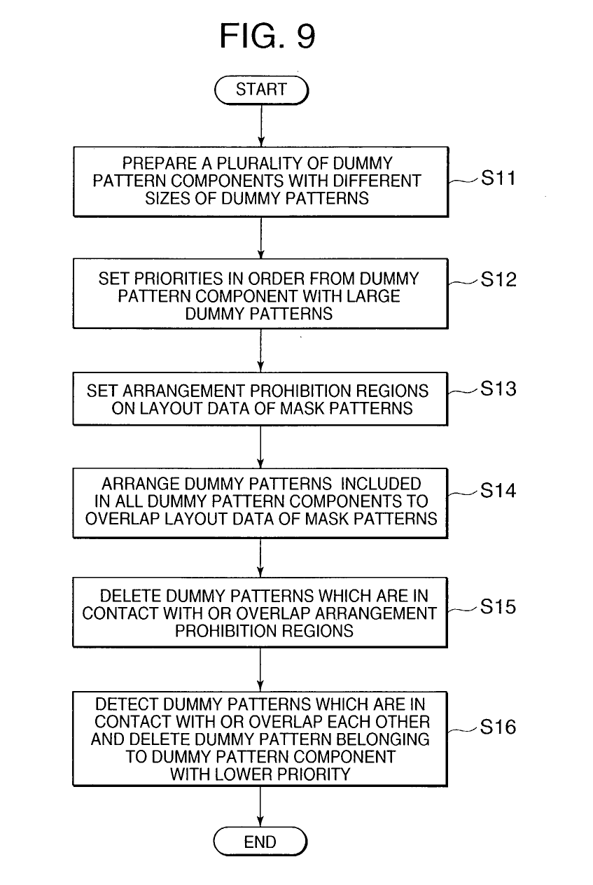

Next, a second embodiment according to the first aspect of the present invention will be described. FIG. 9 is a flow diagram of the second embodiment according to the first aspect of the present invention. The second embodiment is different from the first embodiment in that, after all dummy patterns of a plurality of dummy pattern components are arranged, some dummy patterns are deleted.

First, in step S11, a plurality of dummy pattern components with different sizes of dummy patterns are prepared.

Next, in step S12, priorities of dummy pattern components are set for the prepared plurality of dummy pattern components in an order of sizes of the dummy patterns.

The plurality of dummy pattern components for which priorities are set are prepared according to steps S11 and S12.

Next, in step S13, the computer 11 reads in layout data of mask patterns from the mask pattern data file 13, and the computer 11 sets arrangement prohibition regions of dummy patterns in the layout data of the mask patterns. Steps S11 to S13 are the same as steps S1 to S3 of the first embodiment.

Next, in step S14, the computer 11 arranges dummy patterns included in all the dummy pattern components to overlap the layout data of the mask patterns.

Next, in step S15, when the arranged dummy patterns are in contact with or overlap the arrangement prohibition regions 3, the computer 11 deletes the dummy patterns regardless of priorities of the dummy patterns.

Next, in step S16, in the case in which the plurality of dummy patterns are in contact with or overlap each other, the computer 11 leaves the dummy patterns belonging to the dummy pattern component with a higher priority as they are and deletes the dummy patterns belonging to the dummy pattern component with a lower priority.

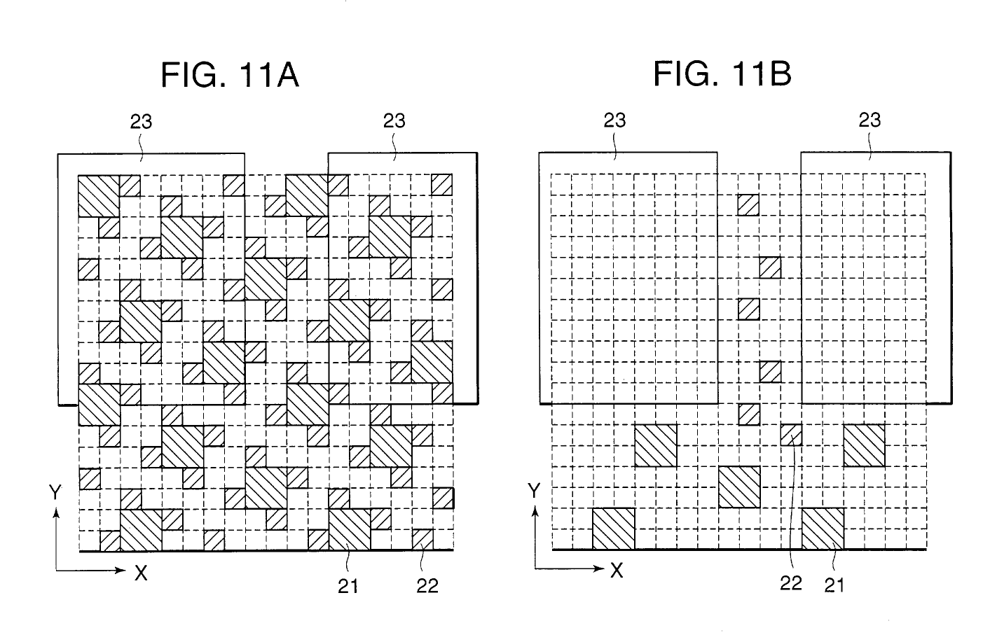

According to the flow of FIG. 9 of the second embodiment, an automatic generation method of dummy patterns is realized which can arrange dummy patterns even in a region with a small interval between two adjacent dummy prohibition regions and can control increase in a data volume as shown in a schematic view of a layout of FIG. 11B in the same manner as the first embodiment. In this embodiment, again, in order to surely arrange dummy patterns in the region with a small interval between adjacent two dummy prohibition regions, it is desirable to set a size of the dummy patterns belonging to the dummy pattern component of a lowest priority (i.e., smallest dummy patterns) to the same size as the grids. Note that step S13 of FIG. 9 may be performed before step S11. In addition, in the description of this embodiment, the case in which dummy patterns and arrangement prohibition regions are arranged on grids is explained. However, the flow of FIG. 9 is not limited to this but can be applied to the case in which dummy patterns and arrangement prohibition regions are arranged without grids.

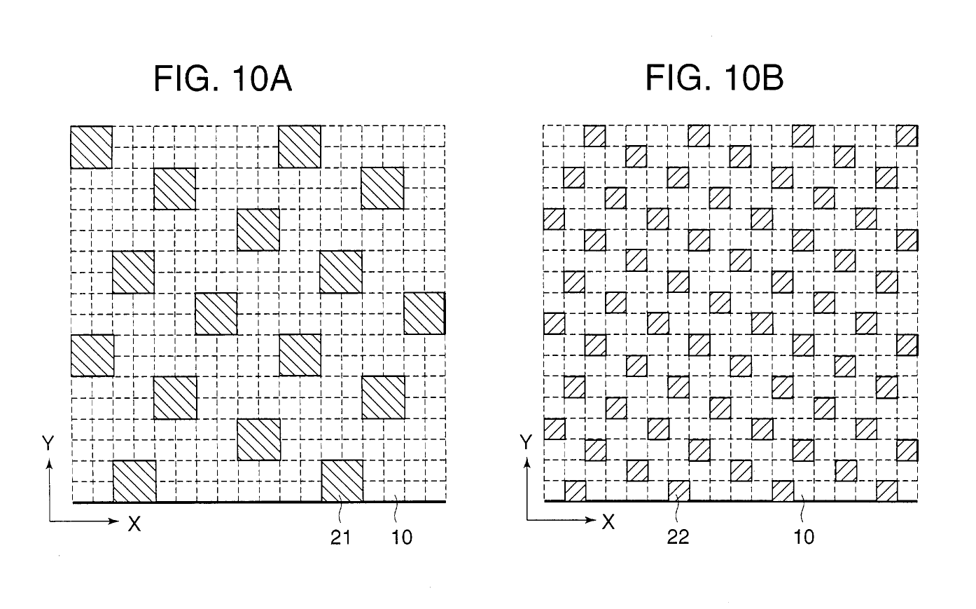

In the first and second embodiments, an arrangement of dummy patterns in a dummy pattern component is not limited to the arrangement on a matrix as shown in FIGS. 5A and 5B but may be an arrangement as shown in FIGS. 10A and 10B as long as the dummy patterns are arranged regularly.

FIG. 11A is a schematic view of a layout at the time of completion of step S14 in the case in which a dummy pattern component having large dummy patterns 21 is as shown in FIG. 10A and a dummy pattern component having small dummy patterns 22 is as shown in FIG. 10B, and automatic generation of dummy patterns is executed in accordance with the flow of FIG. 9. FIG. 11B is a schematic view of a layout at the time of completion of step S16 in the flow of FIG. 9. Note that the flow of FIG. 9 of the second embodiment can be carried out in the case in which there are three or more dummy pattern components.

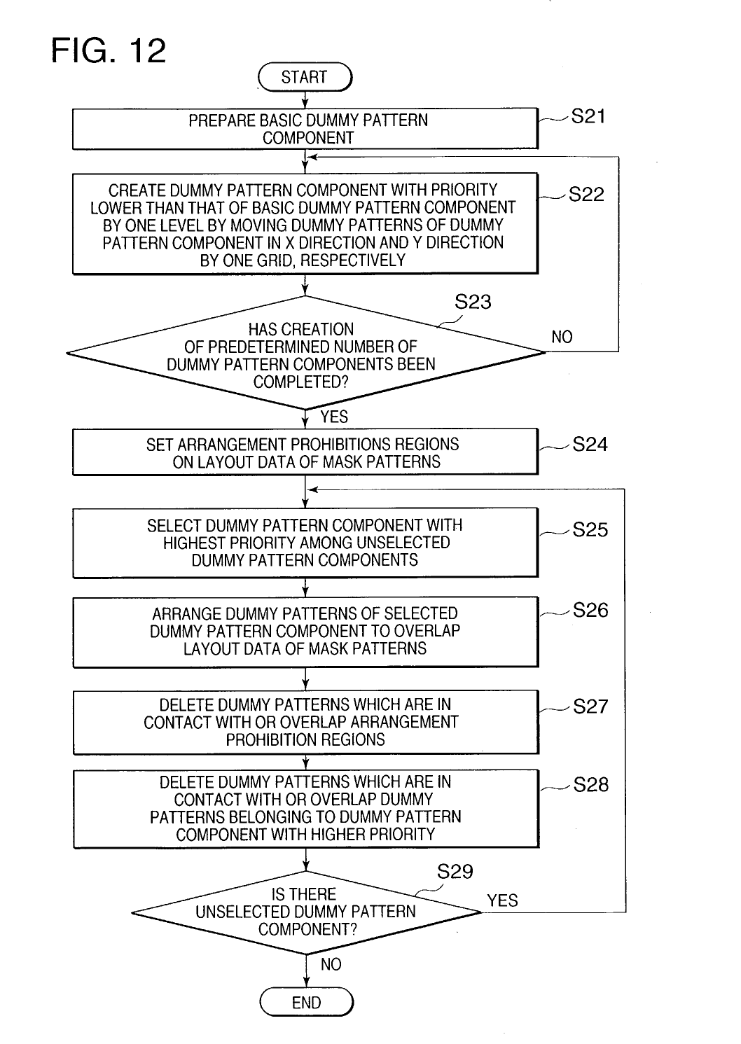

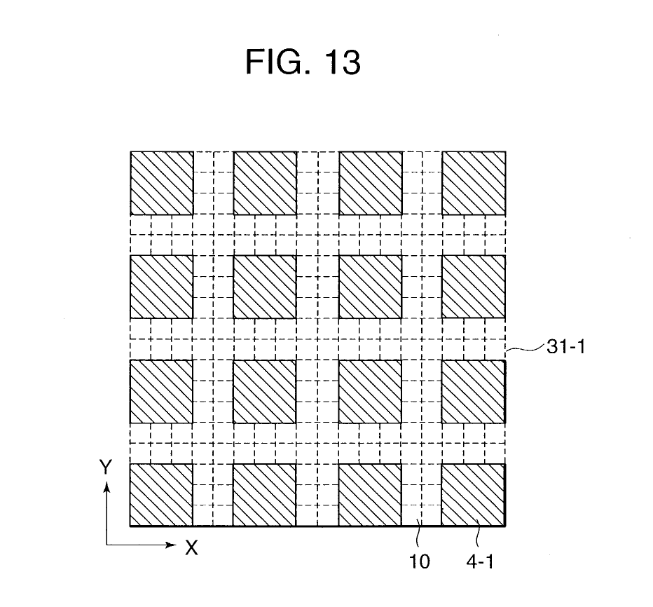

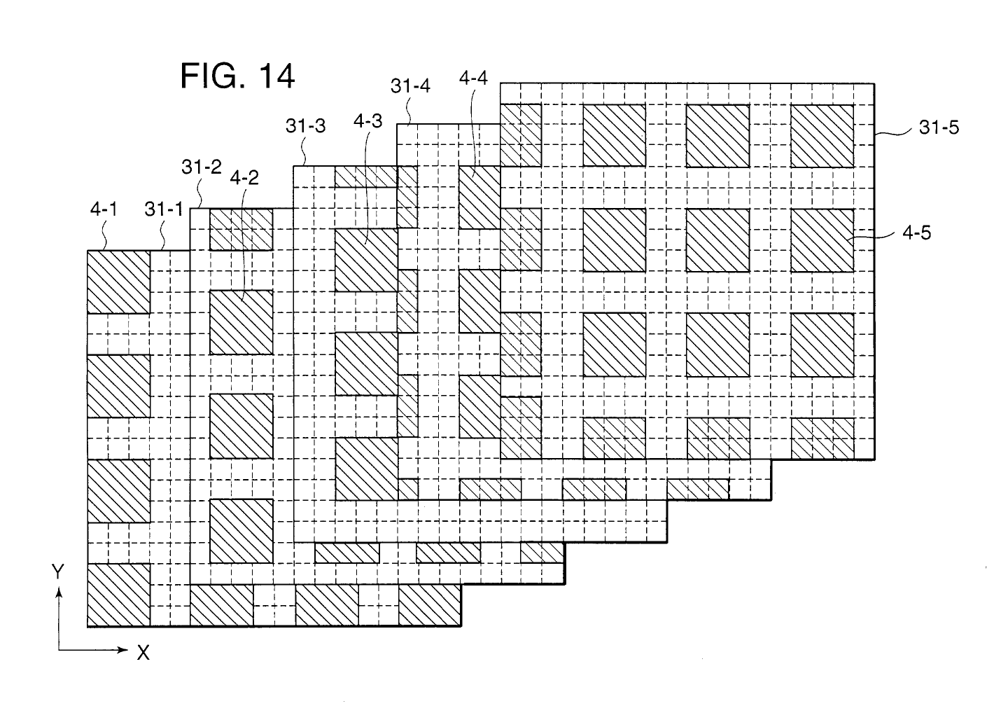

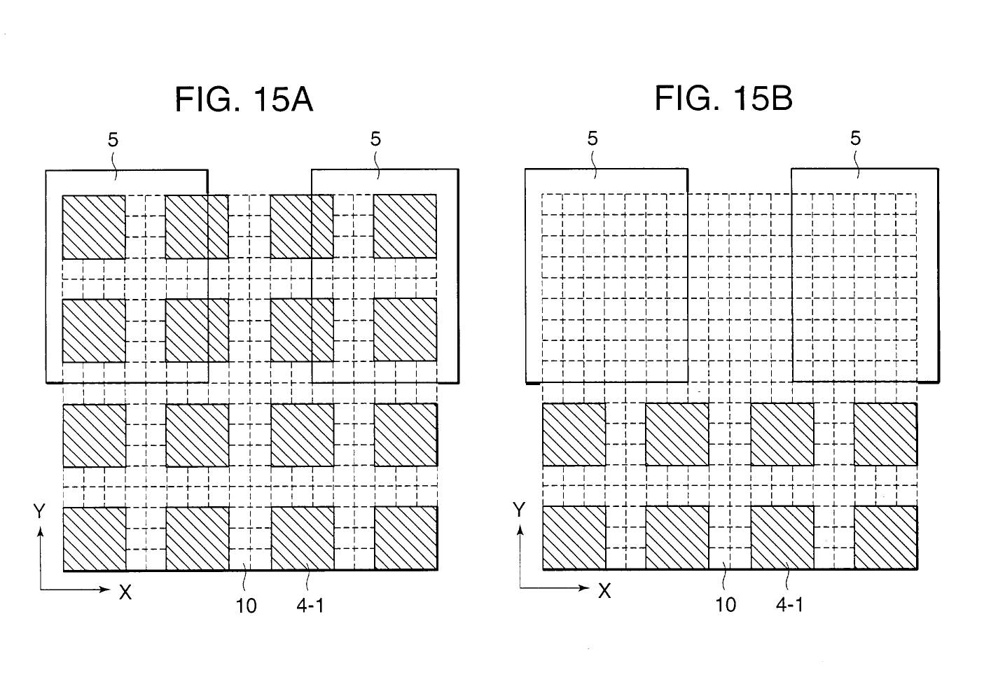

Next, a third embodiment of the first aspect of the present invention will be described. FIG. 12 is a flow diagram of the third embodiment of the first aspect of the present invention. The third embodiment will be described in accordance with the flow diagram of FIG. 12 with reference to FIG. 13 showing a basic dummy pattern component, FIG. 14 showing the basic dummy pattern component and a plurality of dummy pattern components created based upon the basic dummy pattern component, and FIGS. 15A, 15B, 16A, 16B, 17A, and 17B which are schematic views of layouts corresponding to main steps of FIG. 12, as required in the description.

First, in step S21, the basic dummy pattern component is prepared. In a basic dummy pattern component 31-1 shown in FIG. 13, dummy patterns 4-1 are regularly arranged in a matrix shape on the grids 10.

Next, in step S22, the computer 11 creates a new dummy pattern component by moving the dummy patterns of the basic dummy pattern component in an X direction and a Y direction by one grid, respectively, and gives it a priority lower than a priority of the basic dummy pattern component by one level.

In step S23, the computer 11 judges whether or not a predetermined number of dummy pattern components have been created. If the number of created dummy pattern components is less than the predetermined number, the computer 11 replaces the basic dummy pattern component with the dummy pattern component created anew and returns to step S22. If the number of created dummy pattern components has reached the predetermined number, the computer 11 proceeds to step S24.

By executing steps S21 to S23, as shown in FIG. 14, a plurality of dummy pattern components for which priorities are set are prepared. In FIG. 14, reference numeral 31-1 denotes a basic dummy pattern component and 31-2 denotes a dummy pattern component which is created by moving dummy patterns 4 of the dummy pattern component 31-1 in an X direction and a Y direction by one grid, respectively. Reference numeral 31-3 denotes a dummy pattern component which is created by moving the dummy patterns 4 of the dummy pattern component 31-2 in the X direction and the y direction by one grid, respectively. Reference numeral 31-4 denotes a dummy pattern component which is created by moving the dummy patterns 4 of the dummy pattern component 31-3 in the X direction and the Y direction by one grid, respectively. Reference numeral 31-5 denotes a dummy pattern component which is created by moving the dummy patterns 4 of the dummy pattern component 31-4 by one grid, respectively.

Next, in step S24, the computer 11 reads in layout data of mask patterns from the mask pattern data file 13, and the computer 11 sets arrangement prohibition regions of dummy patterns in the layout data of the mask patterns. As shown in FIG. 15A, arrangement prohibition regions 5 are set on the grids 10.

Next, in step S25, the computer 11 selects a dummy pattern component with a highest priority among the unselected dummy pattern components. The dummy pattern component 31-1 of FIG. 14 is selected.

Next, in step S26, the computer 11 arranges the dummy patterns 4 of the selected dummy pattern component 31-1 to overlap the layout data of the mask patterns. As shown in a schematic view of a layout of FIG. 15A, the dummy patterns 4-1 are arranged on the layout data of the mask patterns such that grids of the dummy pattern component 31-1 and grids of the layout data of the mask patterns coincide with each other.

Next, in step S27, when the arranged dummy patterns 4-1 is in contact with or overlap the arrangement prohibition regions 5, the computer 11 deletes the dummy patterns 4-1. As a result, as shown in a schematic view of a layout of FIG. 15B, the dummy patterns 4-1 overlapping the arrangement prohibition regions 5 are deleted, and the dummy patterns 4-1 are not arranged between the two arrangement prohibition regions 5.

Next, in step S28, in the case in which a plurality of dummy patterns are in contact with or overlap each other, the computer 11 leaves dummy patterns belonging to a dummy pattern component with a higher priority as they are and deletes dummy patterns belonging to the dummy pattern component with a lower priority. Since arranged dummy patterns are only the dummy patterns 4-1 belonging to the dummy pattern component 31-1 in FIG. 15B, the computer 11 proceeds to step S29.

In step S29, the computer 11 judges whether or not there is an unselected dummy pattern component. Since the dummy pattern components 31-2 to 31-5 are unselected, the computer 11 returns to step S25.

In step S25, the computer 11 selects the dummy pattern component 31-2 of FIG. 14 which is an unselected dummy pattern component.

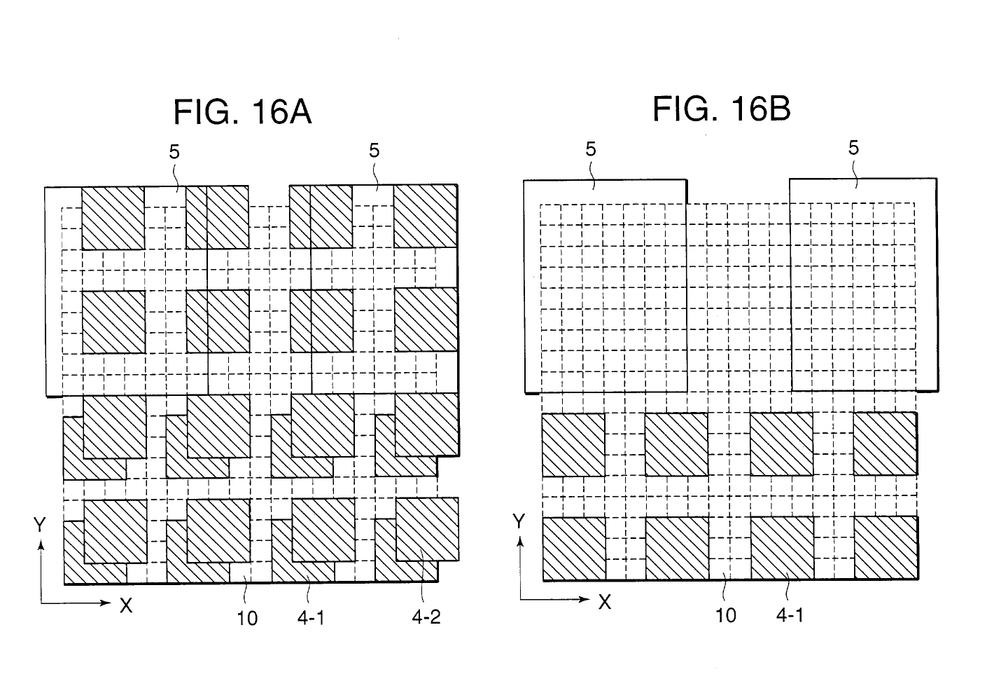

In step S26, the computer 11 arranges dummy patterns 4-2 of the selected dummy pattern component 31-2 to overlap the layout data of the mask patterns. As shown in a schematic view of a layout of FIG. 16A, the dummy patterns 4-2 belonging to the dummy pattern component 31-2 are arranged on the layout data of the mask patterns such that grids of the dummy pattern component and grids of the layout data of the mask patterns coincide with each other.

In steps S27 and S28, since all the dummy patterns 4-2 are deleted in the case of this embodiment, a layout as shown in a schematic view of FIG. 16B is obtained.

Since it is judged in step S29 that there is an unselected dummy pattern component, the computer 11 returns to step S25 and selects the dummy pattern component 31-3 to execute steps up to step S29. Since dummy patterns 4-3 belonging to the dummy pattern component 31-3 are deleted in steps S27 and S28, a schematic view of a layout after completion of step S28 is the same as FIG. 16B.

Next, since it is judged in step S29 that there is an unselected dummy pattern component, the computer 11 returns to step S25 and selects the dummy pattern component 31-4.

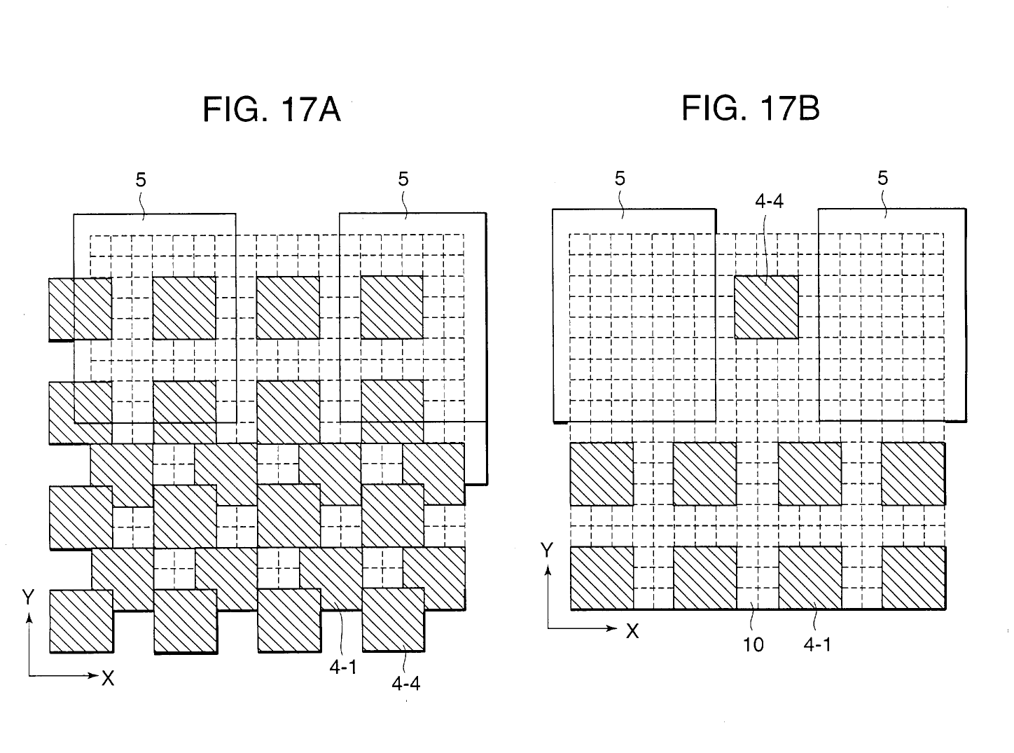

In step S26, the computer 11 arranges dummy patterns 4-4 of the selected dummy pattern component 31-4 to overlap the layout data of the mask patterns. As shown in a schematic view of a layout of FIG. 17A, the dummy patterns 4-4 belonging to the dummy pattern component 31-4 are arranged on the layout data of the mask patterns such that grids of the dummy pattern component and grids of the layout data of the mask patterns coincide with each other.

In step S27, when the arranged dummy patterns 4-4 are in contact with or overlap the arrangement prohibition regions 5, the computer 11 deletes the dummy patterns 4-4. In step S28, in the case in which a plurality of dummy patterns are in contact with or overlap each other, the computer 11 leaves dummy patterns belonging to a dummy pattern component with a higher priority as they are and deletes dummy patterns belonging to the dummy pattern component with a lower priority. As a result, the dummy patterns 4-4 other than those arranged between the two arrangement prohibition regions 5 are deleted, and a layout as shown in a schematic view of FIG. 17B is obtained.

Since it is judged in step S29 that there is an unselected dummy pattern component, the computer 11 returns to step S25 and selects the dummy pattern component 31-5 to execute steps up to step S29. Since the dummy patterns 4-5 belonging to the dummy pattern component 31-5 are deleted in steps S27 and S28, a schematic view of a layout after completion of step S28 is the same as FIG. 17B. Since it is judged in step S29 that there is no unselected dummy pattern component, the computer 11 ends automatic generation of dummy patterns.

According to the method of this embodiment, as shown in the schematic view of the layout of FIG. 17B, since the dummy patterns 4-4 are arranged between the two arrangement prohibition regions 5 and the dummy patterns 4-1 are arranged in a vacant region with a large area, an automatic generation method of dummy patterns is realized which can arrange dummy patterns even in a region with a small interval between adjacent two dummy prohibition regions and can control increase in a data volume. Note that step S24 of FIG. 12 may be performed before step S21.

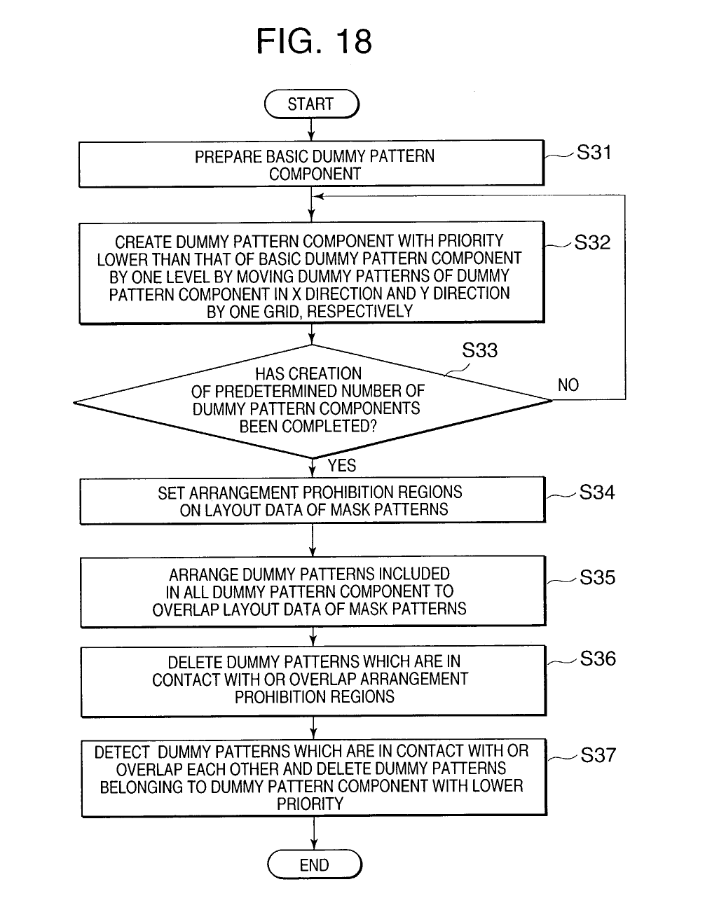

Next, a fourth embodiment according to the first aspect of the present invention will be described. FIG. 18 is a flow diagram of the fourth embodiment according to the first aspect of the present invention. The fourth embodiment is different from the third embodiment in that, after all dummy patterns of a plurality of dummy pattern components are arranged, some dummy patterns are deleted.

First, in step S31, a basic dummy pattern component is prepared. It is assumed that the dummy pattern component 31-1 of FIG. 13 is the basic dummy pattern component as in the third embodiment.

Next, in step S32, the computer 11 creates a new dummy pattern component by moving dummy patterns of the basic dummy pattern component in an X direction and a Y direction by one grid, respectively, and gives it a priority which is lower than a priority of the basic dummy pattern component by one level.

In step S33, the computer 11 judges whether or not a predetermined number of dummy pattern components have been created. If the number of created dummy pattern components is less than the predetermined number, the computer 11 replaces the basic dummy pattern component with the dummy pattern component created anew and returns to step S32. If the number of created dummy pattern components has reached the predetermined number, the computer 11 proceeds to step S34.

By executing steps S31 to S33, as shown in FIG. 14, a plurality of dummy pattern components for which different priorities are set, respectively, are prepared.

Next, in step S34, the computer 11 reads in layout data of mask patterns from the mask pattern data file 13, and the computer 11 sets arrangement prohibition regions of dummy patterns in the layout data of the mask patterns.

Next, in step S35, the computer 11 arranges dummy patterns included in all the dummy pattern components to overlap the layout data of the mask patterns. The dummy patterns of each dummy pattern component are arranged on the layout data of the mask patterns such that grids of the dummy pattern component and grids of the layout data of the mask patterns coincide with each other.

Next, in step S36, when the arranged dummy patterns 4-1 are in contact with or overlap the arrangement prohibition regions 5, the computer 11 deletes the dummy patterns.

Next, in step S37, in the case in which the plurality of dummy patterns are in contact with or overlap each other, the computer 11 leaves dummy patters belonging to a dummy pattern component with a higher priority as they are and deletes dummy patterns belonging to the dummy pattern component with a lower priority. As a result, an automatic generation method of dummy patterns is realized which can arrange dummy patterns even in a region with a small interval between two adjacent dummy prohibition regions and can control increase in a data volume as shown in the schematic view of the layout of FIG. 17B in the same manner as the third embodiment. Note that step S34 of FIG. 18 may be performed before step S31.

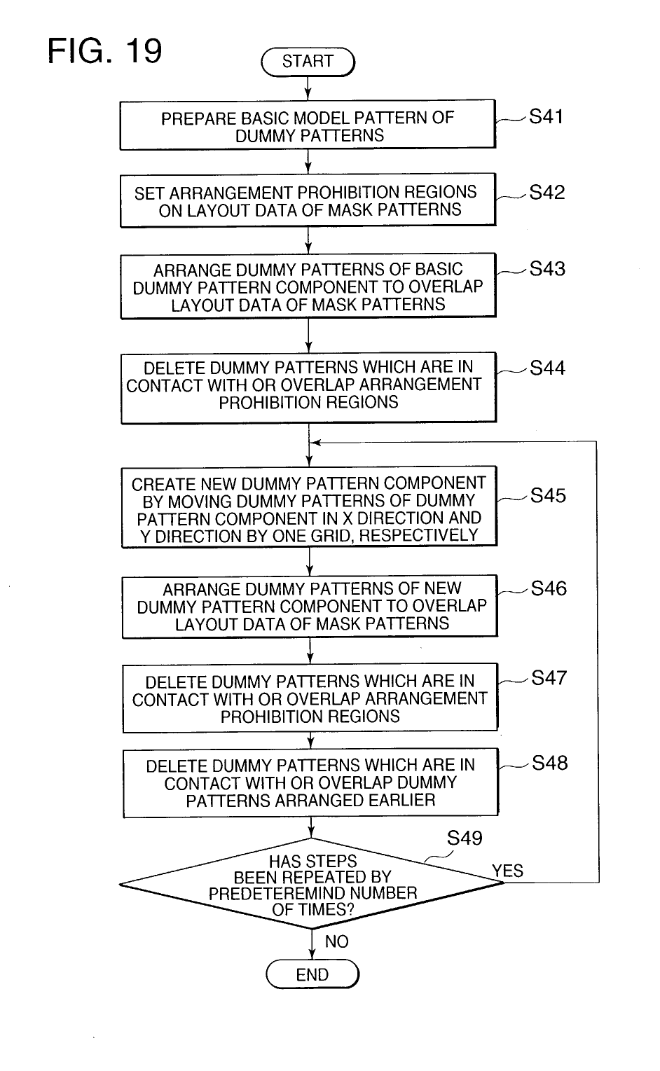

Next a second aspect of the present invention will be described. FIG. 19 is a flow diagram of an embodiment according to the second aspect of the present invention.

First, in step S41, a basic dummy pattern component is prepared.

Next, in step S42, the computer 11 reads in layout data of mask patterns from the mask pattern data file 13, and the computer 11 sets arrangement prohibition regions in the layout data of the mask patterns.

Next, in step S43, the computer 11 arranges dummy patterns of the basic dummy pattern component to overlap the layout data of the mask patterns.

Next, in step S44, when the arranged dummy patterns are in contact with or overlap the arrangement prohibition regions, the computer 11 deletes the dummy patterns.

Next, in step S45, the computer 11 creates a new dummy pattern component by moving the dummy patterns of the basic dummy pattern component in an X direction and a Y direction by one grid, respectively.

Next, in step S46, the computer 11 arranges dummy patterns of the dummy pattern component created anew to overlap the layout data of the mask patterns.

Next, in step S47, when the arranged dummy patterns are in contact with or overlap the arrangement prohibition regions, the computer 11 deletes the dummy patterns.

Next, in step S48, if the dummy patterns arranged anew are in contact with or overlap the dummy patterns arranged earlier, the computer 11 deletes the dummy patterns arranged anew.

Next, in step S49, the computer 11 judges whether or not a number of repetitions from steps S45 to S48 has reached a predetermined number of repetitions. If the number of repetitions has not reached the predetermined number of repetitions, the computer 11 sets the dummy pattern component created anew as a basic dummy pattern component and returns to step S45. If the number of repetitions has reached the predetermined number of repetitions, the computer 11 ends automatic generation of dummy patterns.

In this embodiment, if the dummy pattern component 31-1 shown in FIG. 13 is used as the basic dummy pattern component as in the third embodiment according to the first aspect of the present invention, the dummy patterns 4-1 of the dummy pattern component 31-1 are arranged in step S43. Next, each time steps S45 to S48 are repeated, a dummy pattern component equivalent to the dummy pattern component 31-2, 31-3, 31-4, or 31-5 is generated in step S45 and arranged on the layout data of the mask patterns in step S46, and unnecessary dummy patterns are deleted in steps S47 and S48. As a result, as in the third embodiment according to the first aspect of the present invention, the arrangement of the dummy patterns shown in the schematic view of the layout of FIG. 17B is realized. In this way, in FIG. 19 which shows the flow of the embodiment according to the second aspect of the present invention, an automatic generation method of dummy patterns is also realized which can arrange dummy patterns even in a region with a small interval between adjacent two dummy prohibition regions and can control increase in a data volume.

As described above, by applying the present invention, an automatic generation method of dummy patterns is realized which can arrange dummy patterns even in a region with a small interval between adjacent two dummy prohibition regions and can control increase in a data volume.

What is claimed is:

1. An automatic generation method of dummy patterns comprising:
a first step of preparing a plurality of dummy pattern components which have regularly arranged dummy patterns, respectively, and for which priorities are set based upon a predetermined rule;
a second step of selecting one of the plurality of dummy pattern components and arranging dummy patterns belonging to the selected dummy pattern component to overlap layout data of mask patterns for which arrangement prohibition regions are set;
a third step of deleting dummy patterns which are in contact with or overlap the arrangement prohibition regions among the arranged dummy patterns; and
a fourth step of deleting dummy patterns belonging to a dummy pattern component with a lower priority in the case in which the plurality of dummy patterns are in contact with or overlap each other.

2. The automatic generation method of dummy patterns according to claim 1,
wherein the plurality of dummy pattern components have different sizes of dummy patterns, respectively, and, in the first step, a priority of a dummy pattern component with a largest size of dummy patterns among the plurality of dummy pattern components is set to be highest and priorities of dummy patterns are set to be lower as the sizes of the dummy patterns decrease.

3. The automatic generation method of dummy patterns according to claim 2,
wherein, after the first step is executed, the second step, the third step, and the fourth step are repeated a number of times equivalent to the number of the dummy pattern components prepared in the first step.

4. The automatic generation method of dummy patterns according to claim 2,
wherein, after the first step is executed, the second step is repeated a number of times equivalent to the number of the dummy pattern components prepared in the first step and, then, the third step and the fourth step are executed.

5. The automatic generation method of dummy patterns according to claim 2,
wherein the layout data of the mask patterns are arranged on grids for wiring in advance, dummy patterns of each of the plurality of dummy pattern components are arranged on grids for wiring in advance and, in the second step, the dummy patterns belonging to the selected dummy pattern component are arranged to overlap the layout data of the mask pattern such that both the grids for wiring of the selected dummy pattern component and the layout data of the mask patterns coincide with each other.

6. The automatic generation method of dummy patterns according to claim 5, wherein the dummy pattern component with a lowest priority has dummy patterns of a size identical with the grids for wiring.

7. The automatic generation method of dummy patterns according to claim 5,
wherein, after the first step is executed, the second step, the third step, and the fourth step are repeated a number of times equivalent to the number of the dummy pattern components prepared in the first step.

8. The automatic generation method of dummy patterns according to claim 5,
wherein, after the first step is executed, the second step is repeated a number of times equivalent to the number of the dummy pattern components prepared in the first step and, then, the third step and the fourth step are executed.

9. The automatic generation method of dummy patterns according to claim 1,
wherein the layout data of the mask patterns is arranged on grids for wiring in advance and the dummy patterns of the dummy pattern components are arranged on grids for wiring in advance,
in the first step, the plurality of dummy pattern components are prepared by, every time dummy patterns of a basic dummy pattern component are moved in an X direction and a Y direction by one grid for wiring, respectively, creating a new dummy pattern component with a priority lower than that of the basic dummy pattern component by one level, and
in the second step, the dummy patterns belonging to the selected dummy pattern component are arranged to overlap the layout data of the mask patterns such that both the grids for wiring of the selected dummy pattern component and the layout data of the mask patterns coincide with each other.

10. The automatic generation method of dummy patterns according to claim 9,
wherein, after the first step is executed, the second step, the third step, and the fourth step are repeated a number of times equivalent to the number of the dummy pattern components prepared in the first step.

11. The automatic generation method of dummy patterns according to claim 9,
wherein, after the first step is executed, the second step is repeated a number of times equivalent to the number of the dummy pattern components prepared in the first step and, then, the third step and the fourth step are executed.

12. An automatic generation method of dummy patterns comprising:
a first step of preparing a basic dummy pattern component having dummy patterns regularly arranged on grids for wiring;
a second step of arranging the dummy patterns of the basic dummy pattern component to overlap layout data of mask patterns arranged on grids for wiring in advance such that both the grids for wiring coincide with each other;
a third step of deleting dummy patterns which are in contact with or overlap arrangement prohibition regions among the dummy patterns of the basic dummy pattern component;
a fourth step of moving the dummy patterns of the basic dummy pattern component to an X direction and a Y direction by one grid for wiring, respectively, to create a new dummy pattern component;
a fifth step of arranging dummy patterns of the new dummy pattern component such that grids for wiring coincides with the layout data of the mask patterns;
a sixth step of deleting dummy patterns which are in contact with or overlap the arrangement prohibition regions among the dummy patterns of the new dummy pattern component;
a seventh step of deleting dummy patterns which are in contact with or overlap dummy patterns arranged earlier than the fifth step among the dummy patterns belonging to the new dummy pattern component; and
an eighth step of judging whether or not the fourth to seventh steps are repeated a predetermined number of times and, in the case in which the steps have not been repeated the predetermined times, returning to the fourth step with the new dummy pattern component as a basic dummy pattern component.
